(19) United States
(12) Patent Application Publication
(10) Pub. No.: US 2025/0270362 A1
(43) Pub. Date: Aug. 28, 2025

(54) METHOD FOR PRODUCING MODIFIED POLYMERS AND RUBBER COMPOSITIONS USING THE SAME

(71) Applicant: The Goodyear Tire & Rubber Company, Akron, OH (US)

(72) Inventor: Kelsey Elizabeth Noyes, Canton, OH (US)

(21) Appl. No.: 18/588,625

(22) Filed: Feb. 27, 2024

(51) Int. Cl. C08F 299/00; B60C 1/00; C08G 83/00

(52) U.S. Cl. CPC C08F 299/00; B60C 1/00; C08G 83/003; C08F 2810/40

(57) ABSTRACT

In accordance with the purpose(s) of the present disclosure, as embodied and broadly described herein, the disclosure, in one aspect, relates to a method for making branched polymers. In one aspect the method comprises reacting a first elastomeric polymer (1EP) with a molar excess of a second elastomeric polymer (2EP) to produce a first mixture comprising a third elastomeric polymer (3EP) and 2EP. 1EP and 2EP each individually comprise a polymer with a first terminus and a second terminus, where a residue of a silane polymerization initiator is covalently bonded to the first terminus of the polymer and where the polymers and silane polymerization initiators of 1EP and 2EP can be the same or different. 1EP further comprises a residue of a silane polymerization terminator covalently bonded to the second terminus of the polymer. The method further comprises hydrolyzing the first mixture so that 2EP and 3EP react with one another to produce a branched polymer. Polymers produced by this method can be included in articles comprising rubber compositions, such as tires or components of tires.

### BACKGROUND

Polymers functionalized with various moieties are useful in a variety of systems. In some aspects, functionalized polymers can be a part of rubber compositions, such as those used in the production of tires and components of tires. The extent of branching present in the polymer can have an influence on various properties of the resulting rubber composition or tire. In the case of tires or components of tires, the extent of branching can affect properties such as the tread wear and hysteresis characteristics.

### SUMMARY

In accordance with the purpose(s) of the present disclosure, as embodied and broadly described herein, the disclosure, in one aspect, relates to a method for making branched polymers. In one aspect, the method comprises reacting a first elastomeric polymer (1EP) with a molar excess of a second elastomeric polymer (2EP) to produce a first mixture comprising a third elastomeric polymer (3EP) and 2EP. 1EP and 2EP each individually comprise a polymer with a first terminus and a second terminus, where a residue of a silane polymerization initiator is covalently bonded to the first terminus of the polymer and where the polymers and silane polymerization initiators of 1EP and 2EP can be the same or different. 1EP further comprises a residue of a silane polymerization terminator covalently bonded to the second terminus of the polymer. The method further comprises hydrolyzing the first mixture so that 2EP and 3EP react with one another to produce a branched polymer. Polymers produced by this method can be included in articles comprising rubber compositions, such as tires or components of tires.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used in the specification and the appended claims, the singular forms “a,” “an,” and “the” include plural referents unless the context clearly dictates otherwise. Thus, for example, reference to “a branched polymer” includes, but is not limited to, mixtures or combinations of two or more such branched polymers and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to “y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

The terms “rubber composition”, “compounded rubber”, and “rubber compound” are used herein interchangeably, unless indicated otherwise. The terms refer to rubber which has been blended or mixed with various ingredients and materials.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat.

Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the partially saturated elastomers described herein are derived from monomers used to produce the partially saturated elastomers. For example, polybutadiene has the repeat unit as provided below.

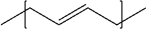

In certain aspects, when the partially saturated elastomer is the polymerization product of two different monomers (e.g., A and B), the repeat unit can be represented by -A-B-.

As used herein, the term “residue”, as in a residue of a chemical species, refers to the moiety that is the resulting product of the chemical species in a particular reaction scheme or subsequent formulation or chemical product, regardless of whether the moiety is actually obtained from the chemical species. Thus, a silane residue, such as a silane polymerization initiator, in a polymer refers to one or more silane units in the polymer, regardless of whether a silane was used to prepare the polymer.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon.

The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “aryl” or “aryl group” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl.

The term “aliphatic” or “aliphatic group,” as used herein, denotes a hydrocarbon moiety that may be straight-chain (i.e., unbranched), branched, or cyclic (including fused, bridging, and spirofused polycyclic) and may be completely saturated or may contain one or more units of unsaturation, but which is not aromatic. Unless otherwise specified, aliphatic groups contain 1-20 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The terms “amine” or “amino” as used herein are represented by the formula-NA¹A², where A¹ and A² can be, independently, hydrogen, alkyl, or cycloalkyl as described herein. A specific example of an amino is-NH₂.

The term “hydrolysable group” as used herein is a group that can undergo a hydrolysis reaction. A hydrolysis reaction can be performed under acid, alkaline, or neutral conditions. Examples of hydrolysable groups include, but are not limited to, alkoxy groups, esters, amides, amines, and nitriles.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹—OA² or —OA¹—(OA²) a —OA³, where “a” is an integer of from 1 to 200 and A¹, A², and A³ are alkyl and/or cycloalkyl groups.

Unless otherwise specified, pressures referred to herein are based on atmospheric pressure (i.e. one atmosphere).

### Methods for Producing Branched Polymers

The use of polymers with branching to various extents in rubber compositions can affect the properties of the rubber. For example, the use of branched polymers in tire components can affect properties such as tread wear and hysteresis. Disclosed herein are methods of making or producing branched polymers. In some aspects, the branched polymer produced is a dendrimer. The branched polymers can be used in articles comprising rubber compositions. In some aspects, the articles can include tires or components of tires.

Disclosed herein is a method for making a branched polymer, the method comprising (a) reacting a first elastomeric polymer (1EP) with a molar excess of a second elastomeric polymer (2EP) to produce a first mixture comprising a third elastomeric polymer (3EP) and 2EP and (b) hydrolyzing the first mixture so that 2EP and 3EP react with one another to produce the branched polymer. In some aspects, 1EP comprises a first polymer with a first terminus and a second terminus, where a residue of a first silane polymerization initiator (I) is covalently bonded to the first terminus of the first polymer and a residue of a silane polymerization terminator is covalently bonded to the second terminus of the polymer. In some aspects, 2EP comprises a second polymer with a first terminus and a second terminus, where a residue of a second silane polymerization initiator is covalently bonded to the second terminus of the second polymer. In some aspects, the first polymer is the same as the second polymer. In other aspects, the first polymer is different from the second polymer. In some aspects, the first silane polymerization initiator is the same as the second silane polymerization initiator. In other aspects, the first silane polymerization initiator is different from the second silane polymerization initiator.

In some aspects, step (a) of this method can be represented by the following reaction scheme:

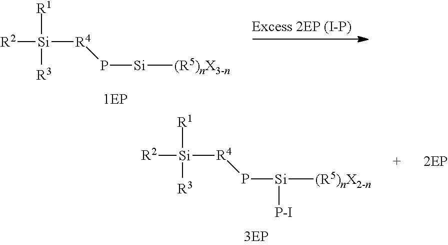

wherein,

R¹, R², and R³ can be independently selected from an alkyl group, a primary amine, a secondary amine, a tertiary amine, and a hydrolysable group, where at least one of R¹, R², and R³ is a hydrolysable group; R⁴ can be an alkene, such as —C═C—, or an epoxy group; R⁵ can be an aryl group or an aliphatic group directly bonded to Si; P can be an unsaturated polymer; X can be a halide directly bonded to Si; and n can be 0, 1, or 2. In some aspects, 2EP (also referred to herein as I-P) can be represented by the following structure:

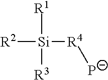

wherein R¹-R⁴ and P are as defined above.

In step (a), there is a molar excess of 2EP relative to 1EP. In one aspect, the molar ratio of 2EP to 1EP is greater than 1:1 to about 2:1, or about 1.15:1, 1.25:1, 1.5:1, 1.75:1, or 2:1, where any value can be a lower and upper endpoint of a range (e.g., 1:5:1 to 2:1).

In some aspects, 1EP has a structure represented by the following:

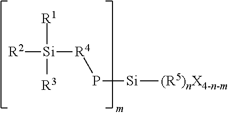

wherein R¹, R², and R³ can be independently selected from an alkyl group, a primary amine, a secondary amine, a tertiary amine, and a hydrolysable group, where at least one of R¹, R², and R³ is a hydrolysable group; R⁴ can be an alkene, such as —C═C—, or an epoxy group; R⁵ can be an aryl group or an aliphatic group directly bonded to Si; P can be an unsaturated polymer; X can be a halide directly bonded to Si; m can be 1, 2, or 3; n can be 0, 1, or 2; and the sum of n and m is no greater than 3. In other aspects, R¹, R², and R³ can be independently selected from a C1-C6 alkyl group and —N(R^{6a})(R^{6b}), where R^{6a} and R^{6b} can be selected from hydrogen and a C1-C6 alkyl group. In some aspects, R⁴ can be —C═C—. In some aspects, R⁵ can be a C1-C6 alkyl group. In some aspects, X can be F or Cl.

In other aspects, 1EP has a structure represented by the following:

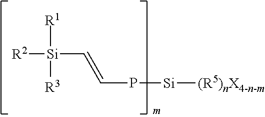

wherein R¹, R², and R³ can be independently selected from an alkyl group, a primary amine, a secondary amine, a tertiary amine, and a hydrolysable group, where at least one of R¹, R², and R³ is a hydrolysable group; R⁵ can be an aryl group or an aliphatic group directly bonded to Si; P can be an unsaturated polymer; X can be a halide directly bonded to Si; m can be 1, 2, or 3; n can be 0, 1, or 2; and the sum of n and m is no greater than 3. In other aspects, R¹, R², and R³ can be independently selected from a C1-C6 alkyl group and —N(R^{6a}) (R^{6b}), where R^{6a} and R^{6b} can be selected from hydrogen and a C1-C6 alkyl group. In some aspects, R⁴ can be —C═C—. In some aspects, R⁵ can be a C1-C6 alkyl group. In some aspects, X can be F or C1.

In one aspect, 1EP can be produced by (1) reacting a conjugated diene with an anionic first silane polymerization initiator to produce a first initiator polymer (1IP) and (2) reacting 1IP with a silane polymerization terminator to produce 1EP. In some aspects, the silane polymerization terminator is Si(R⁵)ₙX₄₋ₙ, wherein each R⁵ can be independently selected from an aryl group or an aliphatic group, X is a halide, and n is 0, 1, or 2. In one aspect, the conjugated diene can be selected from one or more of butadiene, isoprene, pentadiene, octadiene, and any combination thereof. In other aspects, the conjugated diene can be butadiene, isoprene, or a combination thereof. In some aspects, the conjugated diene is copolymerized with a vinyl-substituted aromatic monomer selected from one or more of styrene and vinylnapthalene.

In one aspect, the anionic first silane polymerization initiator can be a silane compound including at least one deprotonated vinyl group or epoxy group. In further aspects, the silane compound can have the following structure:

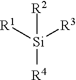

wherein R¹, R², and R³ can be independently selected from an alkyl group, a primary amine, a secondary amine, a tertiary amine, and a hydrolysable group, wherein at least one of R¹, R², and R³ is a hydrolysable group, and R⁴ can be a deprotonated vinyl group or a deprotonated epoxy group. In other aspects, R¹, R², and R³ can be independently selected from a C1-C6 alkyl group and —N(R^{6a}) (R^{6b}), where R^{6a} and R^{6b} can be selected from hydrogen and a C1-C6 alkyl group. In some aspects, R⁴ is a deprotonated vinyl group. In other aspects, the anionic first silane polymerization initiator can have the following structure:

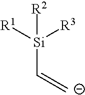

wherein, R¹ and R³ can be independently selected from an alkyl group, a primary amine, a secondary amine, and a tertiary amine; and R² is selected from hydrogen and a C1-C6 alkyl group. In further aspects, R¹ and R³ can be —N(R^{6a}) (R^{6b}), where R^{6a} and R^{6b} can be selected from hydrogen and a C1-C6 alkyl group. In further aspects, R¹ and R³ can be —N(CH₃)₂. In other aspects, R² can be —CH₃.

In one aspect, 2EP can be produced by reacting a conjugated diene with an anionic second silane polymerization initiator. The conjugated diene can be selected from one or more of butadiene, isoprene, pentadiene, octadiene, and any combination thereof. In other aspects, the conjugated diene can be butadiene, isoprene, or a combination thereof. In some aspects, the conjugated diene is copolymerized with a vinyl-substituted aromatic monomer selected from one or more of styrene and vinylnapthalene.

In one aspect, the anionic second silane polymerization initiator can be a silane compound including at least one deprotonated vinyl group or epoxy group. In further aspects, the silane compound can have the following structure:

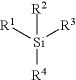

wherein R¹, R², and R³ can be independently selected from an alkyl group, a primary amine, a secondary amine, a tertiary amine, and a hydrolysable group, wherein at least one of R¹, R², and R³ is a hydrolysable group, and R⁴ can be a deprotonated vinyl group or a deprotonated epoxy group. In other aspects, R¹, R², and R³ can be independently selected from a C1-C6 alkyl group and —N(R^{6a}) (R^{6b}), where R^{6a} and R^{6b} can be selected from hydrogen and a C1-C6 alkyl group. In some aspects, R⁴ is a deprotonated vinyl group. In other aspects, the anionic first silane polymerization initiator can have the following structure:

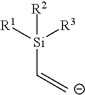

wherein, R¹ and R³ can be independently selected from a primary amine, a secondary amine, and a tertiary amine; and R² can be selected from hydrogen and a C1-C6 alkyl group. In further aspects, R¹ and R³ can be —N(R^{6a}) (R^{6b}), where R^{6a} and R^{6b} can be selected from hydrogen and a C1-C6 alkyl group. In further aspects, R¹ and R³ can be —N(CH₃)₂. In other aspects, R² can be —CH₃. In some aspects, the second silane polymerization initiator has the same structure as the first silane polymerization initiator.

In one aspect, the residue of the first and second silane polymerization initiator can have the structure:

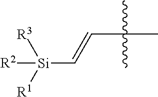

wherein, R¹ and R³ can be independently selected from a primary amine, a secondary amine, and a tertiary amine; and R² can be selected from hydrogen and a C1-C6 alkyl group. In further aspects, R¹ and R³ can be —N(R^{6a}) (R^{6b}), where R^{6a} and R^{6b} can be selected from hydrogen and a C1-C6 alkyl group. In further aspects, R¹ and R³ can be —N(CH₃)₂. In other aspects, R² can be —CH₃.

Step (b) of the process described herein involves hydrolyzing a first mixture composed of 2EP and 3EP so that 2EP and 3EP react with one another to produce the branched polymer. In one aspect, step (b) of the method can be represented by the following reaction scheme:

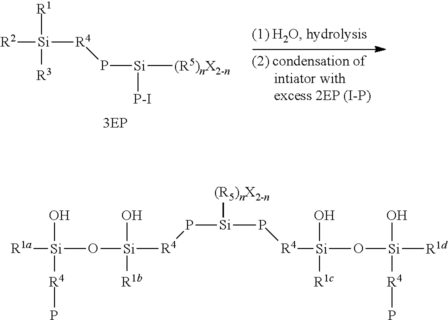

wherein R^{1a}, R^{1b}, R^{1c}, and R^{1d} can be an alkyl group. Condensation can occur essentially simultaneously with the hydrolysis step. Hydrolysis can be performed in the presence of water under acidic or alkaline conditions. Through the hydrolysis step, a hydrolysable functional group present on the polymer is hydrolyzed to form a silanol group. When hydrolysis is performed under acidic conditions, an acidic compound can be added to the reaction mixture. Acidic compounds can include, but are not limited to, inorganic acids (e.g., hydrochloric acid, sulfuric acid, or nitric acid), carboxylic acids (e.g., acetic acid or formic acid), or silicon tetrachloride. When hydrolysis is performed under alkaline conditions, a basic compound can be added to the reaction mixture. Basic compounds can include, but are not limited to, alkali metal hydroxides (e.g., sodium hydroxide). In some aspects, hydrolysis under acidic or basic conditions can include heating the reaction mixture.

Following step (b), further condensation can occur. The following reaction scheme depicts one possible additional condensation step to produce a branched polymer described herein:

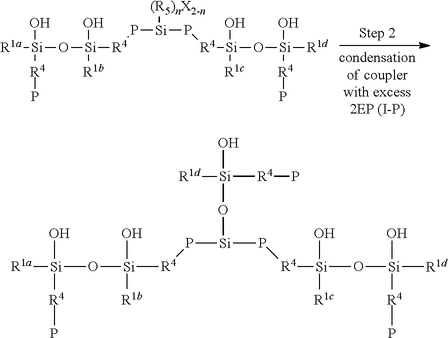

Any residual Si—OH bonds have the possibility of undergoing further condensation, until some stopping point is reached, such as thermodynamic or kinetic equilibrium. With multiple sites where condensation can occur on the in-process branched polymer, further condensation steps can result in the formation of a branched polymer of high molecular weight.

The polymers disclosed herein, such as 1EP, 2EP, and 3EP, can be comprised of repeat units formed by residues of monomers. In some aspects, these monomers are conjugated dienes. In further aspects, the conjugated diene monomers contain from 4 to 8 carbons. The conjugated or unconjugated diene monomers can be substituted with one or more alkyl groups or one or more aryl groups. Examples of diene monomers include, but are not limited to, 1,3-butadiene; isoprene; 1,3-pentadiene; 2,3-dimethyl-1,3-butadiene; 2-methyl-1,3-pentadiene; 2,3-dimethyl-1,3-pentadiene; 2-phenyl-1,3-butadiene; and 4,5-diethyl-1,3-octadiene. In further aspects, the one or more diene monomers can be copolymerized with one or more vinyl-substituted aromatic monomers, such as styrene. For example, styrene-butadiene rubber (SBR). Examples of vinyl-substituted aromatic monomers include, but are not limited to, styrene; 1-vinylnapthalene; 3-methylstyrene; 3,5-diethylstyrene; 4-propylstyrene; 2,4,6-trimethyl styrene; 4-dodecylstyrene; 3-methyl-5-normal-hexylstyrene; 4-phenylstyrene; 2-ethyl-4-benzylstyrene; 3,5-diphenylstyrene; 2,3,4,5-tetraethylstyrene; 3-ethyl-1-vinylnapthalene; 6-isopropyl-1-vinylnapthalene; 6-cyclohexyl-1-vinylnapthalene; 7-dodecyl-2-vinylnapthalene; and α-methylstyrene.

### Rubber Compositions

The polymers disclosed herein can be compounded into a rubber composition. In some aspects, the rubber composition can include, in addition to the branched polymer, one or more unsaturated rubbers or elastomers containing at least one carbon-carbon double bond, including natural rubber in its various raw and reclaim forms as well as various synthetic rubbers. In some aspects, synthetic rubbers can include the homopolymerization products of butadiene and its homologues or derivatives, for example methylbutadiene, dimethylbutadiene, and pentadiene. In further aspects, synthetic rubbers can also include copolymers, such as those formed from butadiene and its homologues or derivatives with other unsaturated monomers including, but not limited to, acetylenes such as vinyl acetylenes; olefins such as isobutylene; vinyl compounds such as acryclic acid, acrylonitrile, methacrylic acid, styrene, vinyl esters; and various unsaturated aldehydes, ketones, and ethers such as acrolein, methyl isopropenyl ketone, and vinylethyl ether. In some aspects, the synthetic rubbers include neoprene (polychloroprene); polybutadiene (including cis-1,4-polybutadiene); polyisoprene (including cis-1,4-polyisoprene); butyl rubber; halobutyl rubber such as chlorobutyl rubber or bromobutyl rubber; styrene-isoprene-butadiene rubber; copolymers of 1,3-butadiene or isoprene with monomers such as styrene; acrylonitrile and methyl methacrylate; ethylene-propylene terpolymers, also known as ethylene-propylene-diene monomer (EPDM); and ethylene-propylene-dicyclopentadiene terpolymers. In some aspects, the cis-1,4-polybutadiene (BR) can be characterized by having at least a 90% cis-1-4 content. BR can be prepared by organic solution polymerization of 1,3-butadiene. In further aspects, synthetic rubbers can include alkoxy-silyl end functionalized solution polymerized polymers (SBR, PBR, IBR, and SIBR), silicon-coupled and tin-coupled star-branched polymers. In other aspects, the rubber or elastomers are polyisoprene (natural or synthetic), polybutadiene, and styrene-butadiene rubber (SBR).

In some aspects, the additional rubber in the rubber composition is comprised of at least two diene-based rubbers. For example, a combination of two or more rubbers such as cis 1,4-polyisoprene rubber (natural or synthetic), 3,4-polyisoprene rubber, styrene-isoprene-butadiene rubber, emulsion and solution polymerization derived styrene-butadiene rubbers, cis 1,4-polybutadiene rubbers, and emulsion polymerization prepared butadiene-acrylonitrile copolymers. In a further aspect, a solution polymerized SBR (S-SBR) can have a bound styrene content in a range of about 5% to about 50% or about 9% to about 36%. The S-SBR can be prepared by conventional methods, such as organo-lithium catalyzation in the presence of an organic hydrocarbon solvent.

In another aspect, an emulsion polymerization derived styrene-butadiene rubber (E-SBR) can be used as the additional rubber. E-SBR is prepared by copolymerizing styrene and 1,3-butadiene as an aqueous emulsion, and the bound styrene content can vary from about 5% to about 50%. In some aspects, the E-SBR has either a relatively conventional styrene content of about 20% to about 28% bound styrene. In other aspects, the E-SBR has a medium to relatively high bound styrene content, for example about 30% to about 45% bound styrene. In further aspects, the E-SBR can also contain acrylonitrile to form a terpolymer rubber, such as E-SBAR. In some aspects, the E-SBAR contains amounts of about 2 wt % to about 30 wt % bound acrylonitrile in the terpolymer.

In further aspects, the rubber composition can also include up to 70 phr of processing oil, optionally added directly during rubber compounding. The processing oil can be included in the rubber compositions as extending oil typically used to extend elastomers. In some aspects, the processing oil comprises both extending oil and process oil added during compounding. In some aspects, the process oils include various oils as are known in the art, including aromatic, paraffinic, naphthenic, vegetable oils, and low PCA oils, such as MES, TDAE, SRAE, and heavy naphthenic oils. In further aspects, low PCA oils include those having a polycyclic aromatic content of less than 3 wt % as determined by the IP346 method. Procedures for the IP346 method can be found in Standard Methods for Analysis & Testing of Petroleum and Related Products and British Standard 2000 Parts, 2003, 62nd edition, published by the Institute of Petroleum, United Kingdom.

In yet further aspects, the rubber composition can include from about 10 to about 150 phr of silica. In other aspects, about 20 to about 80 phr of silica can be used. Siliceous pigments which can be used in the rubber compound include conventional pyrogenic and precipitated siliceous pigments (silica). In one aspect, precipitated silica is used, such as those obtained by the acidification of a soluble silicate, e.g., sodium silicate. In some aspects, conventional silicas can be characterized by a BET (Brunauer-Emmett-Teller) surface area, as measured using nitrogen gas. In one aspect, the BET surface area can be in the range of about 40 m²/g to about 600 m²/g. In another aspect, the BET surface area can be in a range of about 80 m2/g to about 300 m²/g. The BET method of measuring surface area is described in the Journal of the American Chemical Society, Volume 60, Page 304 (1930). In further aspects, the conventional silica can be characterized by having a dibutylphthalate (DBP) absorption value in a range of about 100 to about 400 or about 150 to about 300. In some aspects, the conventional silica can have an average ultimate particle size in the range of about 0.01 μm to about 0.05 μm as determined by an electron microscope. In other aspects, the silica particles are smaller than 0.01 μm. In other aspects, the silica particles are larger than 0.05 μm. In some aspects, commercially available silicas are used, such as silicas commercially available from PPG Industries under the Hi-Sil trademark (with designations 210, 243, and the like); silicas available from Rhodia (with designations of Z1165MP and Z165GR); and silicas available from Degussa AG (with designations of VN2, VN3, and the like).

In further aspects, the rubber composition can include carbon blacks as a conventional filler in an amount ranging from about 10 to about 150 phr or about 20 to about 80 phr. In some aspects, the carbon blacks used include NII0, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 g/kg to 145 g/kg and DBP number ranging from 34 to 150 cm³/100 g.

Other fillers that can be used in the rubber composition include particulate fillers including ultra-high molecular weight polyethylene (UHMWPE), crosslinked particulate polymer gels including those disclosed in U.S. Pat. Nos. 6,242,534; 6,207,757; 6,133,364; 6,372,857; 5,395,891; or 6,127,488, and plasticized starch composite filler including that disclosed in U.S. Pat. No. 5,672,639. The fillers disclosed in these patents are incorporated by reference. In further aspects, these fillers can be used in an amount ranging from about 1 to about 30 phr.

In other aspects, the rubber composition can contain a conventional sulfur containing organosilicon compound in amounts of about 0.5 phr to about 20 phr or about 1 phr to about 10 phr. In further aspects, the sulfur containing organosilicon compounds are 3,3′-bis(trimethoxy or triethoxy silylpropyl) polysulfides. In other aspects, the sulfur containing organosilicon compounds are 3,3′-bis(triethoxysilylpropyl) disulfide and/or 3,3′-bis(triethoxysilylpropyl) tetrasulfide. In other aspects, the sulfur containing organosilicon compounds include compounds disclosed in U.S. Pat. No. 6,608,125, which are incorporated by reference. In other aspects, the sulfur containing organosilicon compounds include 3-(octanoyl-thio)-1-propyltriethoxysilane, CH₃ (CH₂)₆C(═O)—S—CH₂CH₂CH₂Si(OCH₂CH₃)₃ (available commercially as NXT™ from Momentive Performance Materials). In another aspect, the sulfur containing organosilicon compounds include those disclosed in U.S. Pat. No. 10,212,220, which are incorporated by reference. In yet other aspects, the sulfur containing organosilicon compound is Si-363 from Degussa.

### Preparation and Applications of Rubber Compositions

The compositions disclosed herein can be compounded by methods generally known in the rubber compounding art. In some aspects, these methods include mixing the various sulfur-vulcanizable constituent rubbers with various commonly used additive materials, such as sulfur donors; curing aids, such as activators and retarders; processing additives, such as oils, resins (including tackifier resins), and plasticizers; fillers; pigments; fatty acids; zinc oxides; waxes; antioxidants; antiozonants; and peptizing agents. As known to those skilled in the art, depending on the intended use of the sulfur vulcanizable and sulfur-vulcanized material (rubbers), the additives mentioned above are selected and commonly used in conventional amounts. In some aspects, the sulfur donors include elemental sulfur (free sulfur), an amine disulfide, polymeric polysulfide, and sulfur olefin adducts. In other aspects, the sulfur-vulcanizing agent is elemental sulfur. The sulfur-vulcanizing agent can be used in an amount ranging from about 0.5 phr to about 8 phr or about 1.5 phr to about 6 phr. If used, tackifier resins can be present in amounts of about 0.5 phr to about 10 phr, usually about 1 phr to about 5 phr. Typical amounts of processing aids comprise about 1 phr to about 50 phr. Typical amounts of antioxidants and antiozonants include about 1 phr to about 5 phr each. In some aspects, antioxidants used can be diphenyl-p-phenylenediamine and others, such as those disclosed in The Vanderbilt Rubber Handbook (1978), Pages 344 through 346. If used, fatty acids can be present in amounts of about 0.5 phr to about 3 phr. In some aspects, the fatty acids include stearic acid. Typical amounts of zinc oxide includes about 2 phr to about 5 phr. Typical amounts of waxes includes about 1 phr to about 5 phr. In some aspects, microcrystalline waxes are used. Typical amounts of peptizers include about 0.1 phr to about 1 phr. In some aspects, the peptizers can be selected from pentachlorothiophenol and dibenzamidodiphenyl disulfide.

Accelerators are used to control the time and/or temperature required for vulcanization and to improve the properties of the vulcanizate. In one aspect, a single accelerator system can be used, i.e., a primary accelerator. In further aspects, the primary accelerator(s) can be used in amounts ranging from about 0.5 phr to about 4 phr or about 0.8 phr to about 1.5 phr. In other aspects, combinations of a primary and a secondary accelerator can be used, where the secondary accelerator is present in smaller amounts, such as from about 0.05 phr to about 3 phr. In further aspects, delayed action accelerators can be used which are not affected by normal processing temperatures but produce a satisfactory cure at ordinary vulcanization temperatures. In some aspects, the accelerators used are selected from amines, disulfides, guanidines, thioureas, thiazoles, thiurams, sulfonamides, dithiocarbamates, xanthates, and any combination thereof. In one aspect, the primary accelerator is a sulfonamide and, when present, a second accelerator is selected from a guanidine, dithiocarbamate, thiuram, or any combination thereof.

The mixing of the rubber composition can be accomplished by methods generally known in the rubber mixing art. In some aspects, the ingredients are typically mixed in at least two stages, namely, at least one non-productive stage followed by a productive stage. The final curatives including sulfur-vulcanizing agents are typically mixed in the final stage, called the productive mix stage, in which the mixing typically occurs at a temperature, or ultimate temperature, lower than the mix temperature(s) of the preceding non-productive mix stage(s). In some aspects, the rubber composition is subjected to a thermomechanical mixing step. The thermomechanical mixing step can comprise a mechanical working in a mixer or extruder for a period of time suitable in order to produce a rubber temperature between about 140° C. and about 190° C. The duration of the thermomechanical working varies depending on the operating conditions and the volume and nature of the components. In some aspects, the thermomechanical working can range from about 1 minutes to about 20 minutes.

In one aspect, the rubber composition that includes the branched polymer disclosed herein can be incorporated in a variety of rubber articles, including non-pneumatic tires, pneumatic tires, tire components, rubber belts, hoses, shoes, airsprings, engine mounts, and the like. In one aspect, the tire component can be a tire tread, including at least one of tread cap and/or tread base rubber layer; tire sidewall; and tire carcass component, such as a carcass cord ply coat, tire sidewall stiffening insert, an apex adjacent to or spaced apart from a tire bead, wire coat, inner liner tire chafer, or tire bead component. In a further aspect, the tread and/or tires can be built, shaped, molded and cured by various methods which will be readily apparent to those skilled in the art.

In one aspect, a pneumatic tire as disclosed herein can be a race tire, passenger tire, aircraft tire, agricultural, earth-mover, off-the-road, truck tire, or the like. In one embodiment, the tire is a passenger or truck tire. In another embodiment, the tire can also be a radial or bias. In one embodiment, the tire component is intended to be ground-contacting. In another embodiment, the tire component is not ground contacting. In some aspects, vulcanization of the pneumatic tire can be carried out at temperatures ranging from about 100° C. to about 200° C. or 110° C. to about 180° C. Vulcanization processes can include heating in a press or mold or heating with superheated steam or hot air. The tires can be built, shaped, molded, and cured by various methods which are known in the tire making art.

### Aspects

The present disclosure can be described in accordance with the following numbered Aspects, which should not be confused with the claims.
Aspect 1. A method for making a branched polymer, comprising:
   (a) reacting a first elastomeric polymer (1EP) with a molar excess of a second elastomeric polymer (2EP) to produce a first mixture comprising a third elastomeric polymer (3EP) and 2EP, wherein
      the first elastomeric polymer (1EP) comprises a first polymer with a first terminus and a second terminus, wherein a residue of a first silane polymerization initiator is covalently bonded to the first terminus of the first polymer and a residue of a silane polymerization terminator is covalently bonded to the second terminus of the first polymer, and
      the second elastomeric polymer (2EP) comprises a second polymer with a first terminus and a second terminus, wherein a residue of a second silane polymerization initiator is covalently bonded to the first terminus of the second polymer,
      wherein the first silane polymerization initiator is the same or different from the second polymerization initiator,
      wherein the first polymer and the second polymer are the same or different polymer; and
   (b) hydrolyzing the first mixture so that 2EP and 3EP react with one another to produce the branched polymer.
Aspect 2. The method of aspect 1, wherein the molar ratio of 2EP to 1EP is greater than 1:1 to about 2:1.
Aspect 3. The method of aspect 1, wherein 1EP has the structure

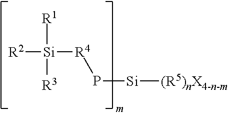

wherein R¹, R², and R³ are independently selected from an alkyl group, a primary amine, a secondary amine, a tertiary amine, and a hydrolysable group, wherein at least one of R¹, R², and R³ is a hydrolysable group;
R⁴ is an alkene or an epoxy group;
R⁵ is an aryl group or an alkyl group directly bonded to Si;
P is an unsaturated polymer;
X is a halide directly bonded to Si;
m is 1, 2, or 3;
n is 0, 1, or 2; and
the sum of n and m is not greater than 3.
Aspect 4. The method of aspect 1, wherein 1EP has the structure

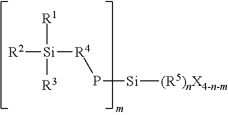

wherein R¹, R², and R³ are independently selected from an alkyl group, a primary amine, a secondary amine, a tertiary amine, and a hydrolysable group, wherein at least one of R¹, R², and R³ is a hydrolysable group;
R⁵ is an aryl group or an alkyl group directly bonded to Si;
P is an unsaturated polymer;
X is a halide directly bonded to Si;
m is 1, 2, or 3;
n is 0, 1, or 2; and
the sum of n and m is not greater than 3.
Aspect 5. The method of aspect 1, wherein 1EP is produced by (1) reacting a conjugated diene with an anionic first silane polymerization initiator to produce a first initiator polymer (1IP), and (2) reacting 1IP with Si(R⁵)ₙX₄₋ₙ to produce 1EP, wherein each R⁵ is independently selected from an aryl group or an aliphatic group, X is a halide, and n is 0, 1, or 2.
Aspect 6. The method of aspect 5, wherein the conjugated diene is selected from one or more of butadiene, isoprene, pentadiene, octadiene, and any combination thereof.
Aspect 7. The method of aspect 5, where the conjugated diene is copolymerized with a vinyl-substituted aromatic monomer selected from one or more of styrene and vinylnapthalene.
Aspect 8. The method of aspect 7, wherein the conjugated diene is butadiene, isoprene, or a combination thereof.
Aspect 9. The method of aspect 5, wherein the anionic first silane polymerization initiator is a silane compound comprising at least one deprotonated vinyl group or epoxy group.
Aspect 10. The method of aspect 5, wherein the anionic first silane polymerization initiator has the structure

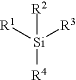

wherein R¹, R², and R³ are independently selected from an alkyl group, a primary amine, a secondary amine, a tertiary amine, and a hydrolysable group, wherein at least one of R¹, R², and R³ is a hydrolysable group, and
R⁴ is a deprotonated vinyl group or a deprotonated epoxy group.
Aspect 11. The method of aspect 5, wherein the anionic first silane polymerization initiator has the structure

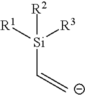

wherein,
R¹ and R³ are independently selected from a primary amine, a secondary amine, and a tertiary amine; and
R² is selected from hydrogen and a C1-C6 alkyl group.
Aspect 12. The method of aspect 11, wherein R² is a C1-C6 alkyl group and R¹ and R³ are —N(R^{6a}) (R^{6b}), wherein R^{6a} and R^{6b} are selected from hydrogen and a C1-C6 alkyl group.
Aspect 13. The method of aspect 11, wherein R¹ and R³ are —N(CH₃)₂ and R² is-CH₃.
Aspect 14. The method of aspect 1, wherein 2EP is produced by reacting a conjugated diene with an anionic second silane polymerization initiator.
Aspect 15. The method of aspect 14, wherein the conjugated diene is selected from one or more of butadiene, isoprene, pentadiene, octadiene, and any combination thereof.
Aspect 16. The method of aspect 14, where the conjugated diene is copolymerized with a vinyl-substituted aromatic monomer selected from one or more of styrene and vinylnapthalene.
Aspect 17. The method of aspect 16, wherein the conjugated diene is selected from one or more of butadiene, isoprene, or a combination thereof.
Aspect 18. The method of aspect 14, wherein the anionic second silane polymerization initiator is a silane compound comprising at least one deprotonated vinyl group or epoxy group.
Aspect 19. The method of aspect 14, wherein the anionic second silane polymerization initiator has the following structure

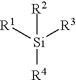

wherein R¹, R², and R³ are independently an alkyl group, a primary amine, a secondary amine, and a tertiary amine, or a hydrolysable group, wherein at least one of R¹, R², and R³ is a hydrolysable group, and
R⁴ is a deprotonated vinyl group or a deprotonated epoxy group.
Aspect 20. The method of aspect 14, wherein the anionic second silane polymerization initiator has the following structure

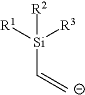

wherein,
R¹ and R³ are independently selected from a primary amine, a secondary amine, and a tertiary amine; and

R² is selected from hydrogen and a C1-C6 alkyl group.
Aspect 21. The method of aspect 20, wherein R² is a C1-C6 alkyl group and R¹ and R³ are —N(R^{6a}) (R^{6b}), wherein R^{6a} and R^{6b} are selected from hydrogen and a C1-C6 alkyl group.
Aspect 22. The method of aspect 20, wherein R¹ and R³ are —N(CH₃)₂ and R² is-CH₃.
Aspect 23. The method of aspect 1, wherein the first and second silane polymerization initiator have the same structure.
Aspect 24. The method of aspect 1, wherein the residue of the first and second silane polymerization initiator have the structure

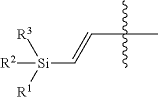

wherein,
R¹ and R³ are independently selected from a primary amine, a secondary amine, and a tertiary amine; and
R² is selected from hydrogen and a C1-C6 alkyl group.
Aspect 25. The method of aspect 1, wherein step (b) comprises heating the first mixture in the presence of water under acidic or alkaline conditions.
Aspect 26. A polymer produced by the method of aspect 1.
Aspect 27. The polymer of aspect 26, wherein the polymer is a dendrimer.
Aspect 28. A rubber composition comprising the polymer of aspect 26.
Aspect 29. An article comprising the rubber composition of aspect 28.
Aspect 30. The article of aspect 29, wherein the article comprises a tire or a component of a tire.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Examples

The following examples are put forth so as to provide those of ordinary skill in the art with a complete disclosure and description of how the compounds, compositions, articles, devices and/or methods claimed herein are made and evaluated. These examples are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1-PROPHETIC

Step (a): P represents an elastomeric polymer formed from conjugated dienes, such as butadiene and isoprene. I represents a functional group capable of hydrolysis and condensation, including silane functional groups. In Step (a), two polymers (I-P and the reactant) can interact to produce a third polymer (the in-process polymer) and I-P.

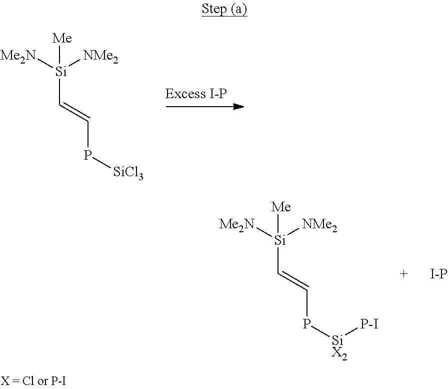

Step (b): The in-process polymer can next undergo hydrolysis (Step 1a), followed by condensation of the initiator I with excess I-P (Step 1b) to produce an intermediate polymer with functional groups, such as the initiator, found along the backbone of the intermediate polymer. In Step 2, the hydrolyzed functional groups can undergo further condensation with I-P or with other functional groups present, leading to the formation of a dendritic polymer of high molecular weight.

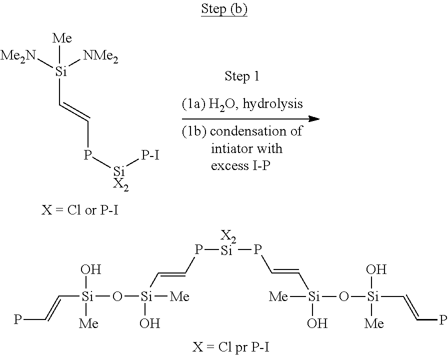

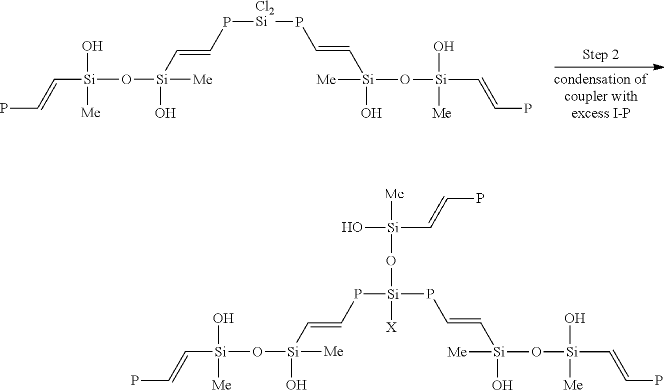

After Step 2, any residual Si—OH bond has the option of undergoing further condensation, until such point as a thermodynamic or kinetic equilibrium is reached.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for making a branched polymer, comprising:
(a) reacting a first elastomeric polymer (1EP) with a molar excess of a second elastomeric polymer (2EP) to produce a first mixture comprising a third elastomeric polymer (3EP) and 2EP, wherein
the first elastomeric polymer (1EP) comprises a first polymer with a first terminus and a second terminus, wherein a residue of a first silane polymerization initiator is covalently bonded to the first terminus of the first polymer and a residue of a silane polymerization terminator is covalently bonded to the second terminus of the first polymer, and
the second elastomeric polymer (2EP) comprises a second polymer with a first terminus and a second terminus, wherein a residue of a second silane polymerization initiator is covalently bonded to the first terminus of the second polymer,
wherein the first silane polymerization initiator is the same or different from the second polymerization initiator,
wherein the first polymer and the second polymer are the same or different polymer; and
(b) hydrolyzing the first mixture so that 2EP and 3EP react with one another to produce the branched polymer.

2. The method of claim 1, wherein the molar ratio of 2EP to 1EP is greater than 1:1 to about 2:1.

3. The method of claim 1, wherein 1EP has the structure 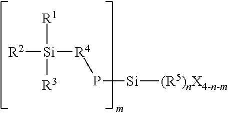
wherein R¹, R², and R³ are independently selected from an alkyl group, a primary amine, a secondary amine, a tertiary amine, and a hydrolysable group, wherein at least one of R¹, R², and R³ is a hydrolysable group;
R⁴ is an alkene or an epoxy group;
R⁵ is an aryl group or an alkyl group directly bonded to Si;
P is an unsaturated polymer;
X is a halide directly bonded to Si;
m is 1, 2, or 3;
n is 0, 1, or 2; and
the sum of n and m is not greater than 3.

4. The method of claim 1, wherein 1EP is produced by (1) reacting a conjugated diene with an anionic first silane polymerization initiator to produce a first initiator polymer (1IP), and (2) reacting 1IP with Si(R⁵), X₄₋ₙ to produce 1EP, wherein each R⁵ is independently selected from an aryl group or an aliphatic group, X is a halide, and n is 0, 1, or 2.

5. The method of claim 4, wherein the conjugated diene is selected from one or more of butadiene, isoprene, pentadiene, octadiene, and any combination thereof.

6. The method of claim 4, where the conjugated diene is copolymerized with a vinyl-substituted aromatic monomer selected from one or more of styrene and vinylnapthalene.

7. The method of claim 4, wherein the anionic first silane polymerization initiator is a silane compound comprising at least one deprotonated vinyl group or epoxy group.

8. The method of claim 4, wherein the anionic first silane polymerization initiator has the structure 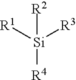
wherein R¹, R², and R³ are independently selected from an alkyl group, a primary amine, a secondary amine, a tertiary amine, and a hydrolysable group, wherein at least one of R¹, R², and R³ is a hydrolysable group, and
R⁴ is a deprotonated vinyl group or a deprotonated epoxy group.

9. The method of claim 8, wherein R² is a C1-C6 alkyl group and R¹ and R³ are —N(R^{6a}) (R^{6b}), wherein R^{6a} and R^{6b} are selected from hydrogen and a C1-C6 alkyl group.

10. The method of claim 1, wherein 2EP is produced by reacting a conjugated diene with an anionic second silane polymerization initiator.

11. The method of claim 10, wherein the conjugated diene is selected from one or more of butadiene, isoprene, pentadiene, octadiene, and any combination thereof.

12. The method of claim 10, where the conjugated diene is copolymerized with a vinyl-substituted aromatic monomer selected from one or more of styrene and vinylnapthalene.

13. The method of claim 10, wherein the anionic second silane polymerization initiator is a silane compound comprising at least one deprotonated vinyl group or epoxy group.

14. The method of claim 10, wherein the anionic second silane polymerization initiator has the following structure: 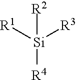
wherein R¹, R², and R³ are independently an alkyl group, a primary amine, a secondary amine, and a tertiary amine, or a hydrolysable group, wherein at least one of R¹, R², and R³ is a hydrolysable group, and
R⁴ is a deprotonated vinyl group or a deprotonated epoxy group.

15. The method of claim 14, wherein R² is a C1-C6 alkyl group and R¹ and R³ are —N(R^{6a}) (R^{6b}), wherein R^{6a} and R^{6b} are selected from hydrogen and a C1-C6 alkyl group.

16. The method of claim 1, wherein the residue of the first and second silane polymerization initiator have the structure 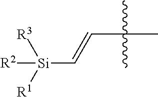
wherein,
R¹ and R³ are independently selected from a primary amine, a secondary amine, and a tertiary amine; and
R² is selected from hydrogen and a C1-C6 alkyl group.

17. A polymer produced by the method of claim 1.

18. A rubber composition comprising the polymer of claim 17.

19. An article comprising the rubber composition of claim 18.

20. The article of claim 19, wherein the article comprises a tire or a component of a tire.
